(19) United States
(12) Patent Application Publication
(10) Pub. No.: US 2020/0380451 A1
(43) Pub. Date: Dec. 3, 2020

(54) METHOD AND SYSTEM FOR SCHEDULING SHIFTS AND EMPLOYEE LEAVE MANAGEMENT

(71) Applicant: SmartMed Inc., Halifax (CA)

(72) Inventor: Arman IZADI, Halifax (CA)

(21) Appl. No.: 16/830,900

(22) Filed: Mar. 26, 2020

Related U.S. Application Data
(60) Provisional application No. 62/853,341, filed on May 28, 2019.

(51) Int. Cl. G06Q 10/06; G06Q 10/10

(52) U.S. Cl. CPC G06Q 10/063116; G06Q 10/1097

(57) ABSTRACT

A computer-implemented method to cause a display device to dynamically render and update a scheduling interface for shift work for at least one employee, comprising: providing, by operation of a computer processor, instructions causing a display device dynamically render and update the scheduling interface for shift work, the scheduling interface comprising: a current schedule comprising: a plurality of classes comprising a group of employees of an organization who are in the same division, region, or department, and perform a certain task or operation with the same shift parameters; and wherein each class of group of employees comprises schedule parameters comprising at least one of a cycle duration, shift location, equipment required for the operation, shift duration, rest-time between shifts, number of mandatory shifts, and off-time after completing all the shifts, and number of employees needed on each team and shift; wherein the schedule comprises a hierarchal honeycomb structure having a plurality of classes; and wherein an employee may be represented by at least a geometrical shape, an avatar and a tag, and wherein at least a geometrical shape, an avatar and a tag is selectable for placement in a pop-up employees pool window movable around the display device; and wherein at least a geometrical shape, an avatar and a tag is selectable for dynamically cause a display of a pop-up employee information window on the display device; and wherein the pop-up employees pool window and the dynamic employee information box and the hierarchical honeycomb structure substantially minimizes the display device real estate attributable to the scheduling interface, thereby the entire current schedule to be displayed on the display device to permit a user to view the entire current schedule at once.

### FIELD

The present disclosure relates scheduling software solutions. In particular, the invention relates to scheduling solutions for shiftwork and leave management.

### BACKGROUND

Scheduling shiftwork employees is a continuous, dynamic and time-consuming process, especially when there are hundreds or thousands of employees to schedule in each cycle. In organizations such as emergency health services (EHS), hospitals, airports, and armed forces, scheduling is particularly demanding.

The limitations of current scheduling software solutions may have the following consequences: the large amount of time scheduling takes; lack of consideration for the effects of the decisions for the current cycle schedule on future schedules; shortages and overages of employees are common; user errors; design often encourages favoritism; necessary data may not be readily available; difficulty in comparing the indicators between different shifts; and the resilience of the current cycle schedule is often ignored. Thus, the problems with the current scheduling may be classified according to their causes such as: schedule structure, presentation of data, lack of future planning, lack of resilience methods, and ignoring the organization's needs.

FIG. 1 shows an exemplary prior art scheduling system 10. Current scheduling systems often utilize a table-based design in which, typically, the employees are listed in rows 12 in a column on the right 14 and the time intervals are listed in columns 16 in the top row of the table, or vice versa. These types of scheduling systems are constrained by the structure and the amount of time it takes to fill in a schedule especially if the schedule is complex. For example, if an organization has 200 employees, there are 200 rows. If the organization has sixteen shifts in a cycle, there are 16 columns. This results in 3200 cells to review for the scheduler. If, in this example, each employee is required to do four shifts, from the sixteen shifts available to each employee, twelve are left empty, which means 75% cells will be left empty. Thus, the scheduler is unable to see the whole schedule to compare different shifts for different indicators such as comparing distribution of skill levels of the employees in an individual shift or between shifts. In the case where specific teams are needed for a particular operation, matching with an employee's preferred team members is not easy.

Furthermore, a table-based structure requires a large amount of screen real estate. For large organizations, many pages and screens are necessary to present the data. Data such as the previous schedule shift data, which may be influential in determining the current cycle schedule, may be difficult to accommodate on the screen as well as the current cycle schedule. As a result, access to, comparing and interpretation of the previous and current shift data of the employees is difficult. If employee details are displayed within the table, then favoritism for certain employees may occur when scheduling advantageous shifts.

Currently, there is no connection between the previous schedule that has been implemented, the current cycle schedule that is being developed, and the next schedules that are not developed yet. Most sophisticated auto-scheduling software solutions consider the connection between the previous cycle and the current cycle schedule; however, assessing how the decisions in the current cycle schedule can affect future schedules is mostly ignored. As a result, overages and shortages in the next cycles may happen. Additionally, there is no method to check and improve the resilience of the current cycle schedule against possible changes to the schedule, such as sick leave or vacation time.

In typical scheduling systems, the connection between the organization's demand and available employees is ignored for employees' leave management. Employees' leave management is usually based on leave entitlement. The organization's needs during a cycle and employee performance are often ignored.

A need therefore, exists for a dynamic scheduling system for shiftwork and leave time that does not require much display real estate and takes into account previous, current, and next schedules as well as the organization's needs.

### SUMMARY

In accordance with an aspect, there is provided a computer-implemented method to cause a display device to dynamically render and update a scheduling interface for shift work for at least one employee, comprising: providing, by operation of a computer processor, instructions causing a display device dynamically render and update the scheduling interface for shift work, the scheduling interface comprising:

a current schedule comprising:
a plurality of classes comprising a group of employees for performing a particular task or operation; and
wherein each class of group of employees comprises schedule parameters comprising at least one of a cycle duration, shift location, equipment required for the operation, shift duration, rest-time between shifts, number of mandatory shifts, and off-time after completing all the shifts, and number of employees needed on each team and shift;

wherein the schedule comprises a hierarchal honeycomb structure having a plurality of classes; and

wherein an employee may be represented by at least a geometrical shape, an avatar and a tag, and wherein at least a geometrical shape, an avatar and a tag is selectable for placement in a pop-up employees pool window movable around the display device; and wherein at least a geometrical shape, an avatar and a tag is selectable for dynamically cause a display of a pop-up employee information window on the display device; and
wherein the pop-up employees pool window and the dynamic employee information box and the hierarchical honeycomb structure substantially minimizes the display device real estate attributable to the scheduling interface, thereby the entire current schedule to be displayed on the display device to permit a user to view the entire current schedule at once.

In accordance with an aspect, there is provided a computer-implemented system for dynamically creating and updating a schedule for shift work comprising:

a processor in communication with at least one database for storing employee data, availability data, resources data, previous scheduling data, leave data;

a scheduling module in communication with the processor and the at least one database for utilizing the employee data, the availability data, resources data, and the previous scheduling data to create the schedule, wherein the schedule comprises a plurality of nested tiers to form a hierarchal honeycomb structure;

a leave management interface module in communication with the processor and the at least one database for processing employee leave data and dynamically updating the schedule based on the employee leave data;

a user interface in communication with the processor, the leave management module and the scheduling module and the at least one database, the user interface accepting user input for dynamically updating the leave management module and the scheduling module, wherein the scheduling module allows user input to dynamically update the schedule via a user interface; and

wherein the hierarchal honeycomb structured schedule is displayed on the user interface.

In accordance with an aspect, there is provided a computer-implemented method for dynamically creating and updating a schedule for shift work, the method implemented utilizing one or more processors for executing computer instructions stored in a computer readable medium to perform the steps comprising:
acquiring employee data, availability data, resources data, previous scheduling data, leave data from at least one database;
creating, via a scheduling module in communication with the at least one database, the schedule based on the employee data, the availability data, resources data, and the previous scheduling data; wherein the schedule is formatted in a plurality of nested tiers to form a hierarchal honeycomb structure;
displaying the hierarchal honeycomb structured schedule via a scheduling interface;
updating dynamically the schedule via a scheduling interface, based on user input:
receiving automatically from the at least one database leave data created by a leave management module in communication with the at least one database; and
updating dynamically the schedule with the leave data

In accordance with an aspect, there is provided a computer program product comprising a non-transitory computer usable medium having a computer readable program code embodied therein, the computer readable program code configured to be executed by a computer processor and cause the computer processor to perform a method for dynamically creating and updating a schedule for shift work, the method comprising the steps of:
acquiring employee data, availability data, resources data, previous scheduling data, leave data from at least one database;
creating, via a scheduling module in communication with the at least one database, the schedule based on the employee data, the availability data, resources data, and the previous scheduling data;
displaying the schedule on a user interface, wherein the schedule is formatted in a plurality of nested tiers to form a hierarchal honeycomb structure;
updating dynamically the schedule via the user interface, based on user input;
receiving automatically from the at least one database leave data created by a leave management module in communication with the at least one database; and
updating dynamically the schedule with the leave data.

### BRIEF DESCRIPTION OF THE DRAWINGS

Several exemplary embodiments will now be described, by way of example only, with reference to the appended drawings in which:

FIG. 1 shows an exemplary screen capture of a prior art table-based scheduling system.

FIG. 2a shows a system diagram for an exemplary dynamic scheduling system

FIG. 2b shows an exemplary computing system.

FIG. 3 shows an exemplary scheduling interface.

FIG. 4 shows a dynamic employee information box from FIG. 3.

FIG. 5 shows an embodiment of the scheduling interface of FIG. 3 in more detail.

FIG. 6 a method for assessing the schedule.

FIG. 7 shows a method for increasing the resilience of a schedule.

FIG. 8 shows a method for managing leave time.

FIG. 9 shows an exemplary leave management interface.

### DETAILED DESCRIPTION OF CERTAIN ASPECTS

The system and method described herein are for a scheduling system for shiftwork employees.

The detailed description of exemplary embodiments of the disclosure herein makes reference to the accompanying block diagrams and schematic diagrams, which show the exemplary embodiment by way of illustration. While these exemplary embodiments are described in sufficient detail to enable those skilled in the art to practice the invention, it should be understood that other embodiments may be realized and that logical and mechanical changes may be made without departing from the spirit and scope of the invention. Thus, the detailed description herein is presented for purposes of illustration only and not of limitation. For example, the steps recited in any of the method or process descriptions may be executed in any order and are not limited to the order presented.

Moreover, it should be appreciated that the particular implementations shown and described herein are merely illustrative and are not intended to otherwise limit the scope of the present claimed method and system in any way. Indeed, for the sake of brevity, certain sub-components of the individual operating components, conventional data networking, application development and other functional aspects of the systems may not be described in detail herein. Furthermore, the connecting lines shown in the various figures contained herein are intended to represent exemplary functional relationships and/or physical couplings between the various elements. It should be noted that many alternative or additional functional relationships or physical connections may be present in a practical system.

Unless otherwise explained, all technical and scientific terms used herein have the same meaning as commonly understood by one of ordinary skill in the art to which this disclosure belongs. In describing and claiming the method and system, the following terminology will be used.

As used herein, a scheduler or user is a person who organizes and updates schedules or manages employee leave requests for an organization.

As used herein, a cycle refers to a period of time for which the schedule is developed, At the end of this period, another schedule is developed. Cycles may be between five to 28 days. A schedule consists of many shifts within the cycle.

As used herein, rest time refers to the amount of time an employee may be mandated for rest after a single shift is completed. For example, if an employee has worked 12-hour shift, employee may be mandated a 12-hour rest time before another shift can be assigned.

As used herein, off-time refers to a time period after completion of all the shifts of one cycle.

As used herein, fixed shifts refers to schedules that start and end at same time each day and usually with no day-night rotations.

As used herein, inter-rotational shifts refers to day-night rotation shifts occurring within each cycle. For example, an employee may have two day-time shifts and two-night time shifts within one cycle.

As used herein, inter-rotational shifts refers to a cycle in which an employee has only day-time shifts and in the next cycle, only night-time shifts, and vice-versa.

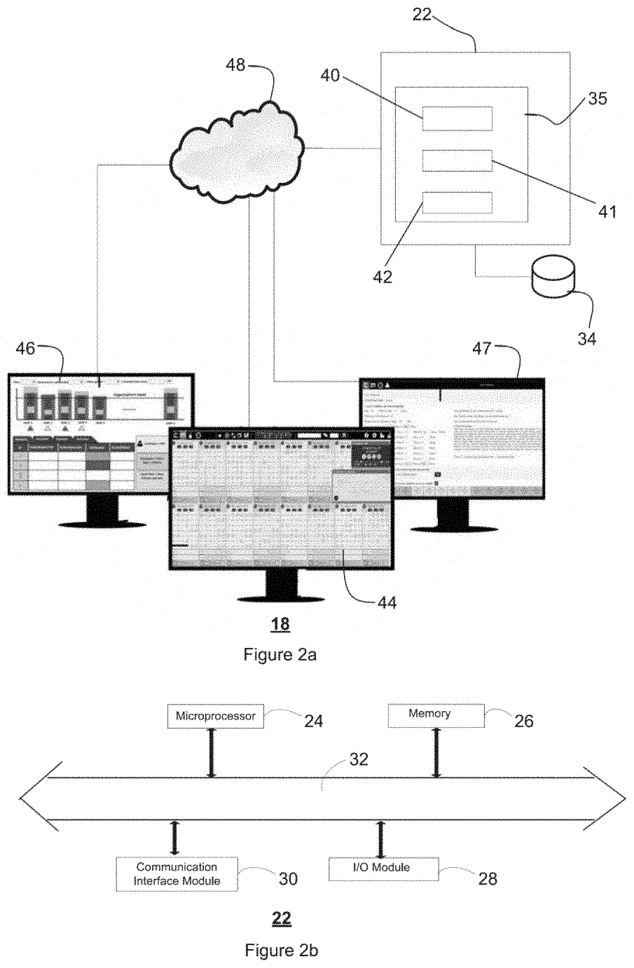

Referring to FIG. 2a there is shown a top-level component architecture diagram implementing a platform based for a method for scheduling shifts and employee leave management, generally indicated by numeral 18. FIGS. 2a and 2b show an embodiment of a scheduling system 20 for scheduling shifts and managing employee leave. Scheduling system 20 comprises a computing system 22, such as a server, comprising at least one processor such as processor 24, at least one memory device such as memory 26, input/output (I/O) module 28 and communication interface 30, which are in communication with each other via centralized circuit system 32, as shown in FIG. 2b. Although computing system 22 is depicted to include only one processor 24, computing system 22 may include a number of processors therein. In an embodiment, memory 26 is capable of storing machine executable instructions, data models and process models. Database 34 is coupled to computing system 22 and stores employee data, scheduling data, leave management data, among others. Further, the processor 24 is capable of executing the instructions in memory 26 to implement aspects of processes described herein. For example, processor 24 may be embodied as an executor of software instructions, wherein the software instructions may specifically configure processor 24 to perform algorithms and/or operations described herein when the software instructions are executed. Alternatively, processor 24 may be configured to execute hard-coded functionality. Scheduling system 20 may include a scheduling engine 35, comprising software (e.g., code segments compiled into machine code), hardware, embedded firmware, or a combination of software and hardware, according to various embodiments.

The scheduling engine 35 may have, at least, several modules which are implemented by the scheduling engine 35. These modules can be implemented as separate, dedicated modules or as combined modules. Additionally, these modules may be implemented as separate dedicated processors or a single or several processors to provide the function of these tools. The modules include a scheduling module 40, a leave management module 41, an employee module 42. A plurality of interfaces, such as a scheduling interface 44, a leave management interface 46 and an employee interface 47 are communicatively coupled to the computing system, the scheduling module 40, leave management module 41, employee module 42, respectively, and the database 34 via network 48. Each interface 44, 46 or 47 may be accessed with the appropriate user credentials on computers, mobile devices, tablets and any other personal computing device, which communicate with the computing system 22 connected to the database 34 via a network 48. The scheduling interface 44 may be used by schedulers to create, maintain, and update the schedules. The leave management interface 46 may be used to approve or reject employees' leave requests. The leave management interface 46 may be used by any person responsible for leave management such as a dedicated HR employee. The employee interface 47 may be used by individual employees to submit their leave or schedule requests. The employee interface 47 acts as a communication tool between the scheduler and the leave management interface 46.

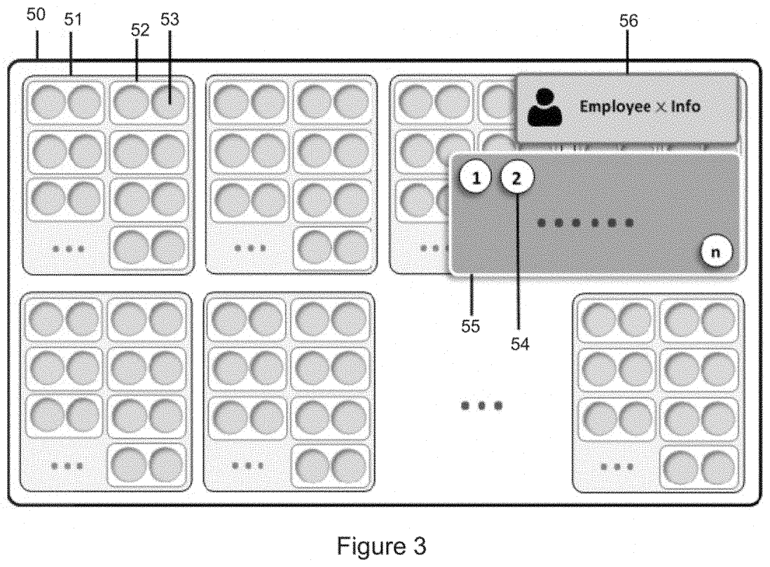

An exemplary scheduling interface 44 is shown in more detail in FIG. 3. In this embodiment, the scheduling interface 44 presents the information to the user in a hierarchal honeycomb pattern.

When the scheduling system 20 is implemented for the first time, data regarding the organization's employees and vehicles or equipment data is recorded and stored on the server database 34. The employees are first organized into a plurality of first tiers or classes. A class refers to a group of employees of the organization who are in the same division, region, or department, and perform a certain task or operation with the same shift parameters. Each class of employees may have its own schedule parameters. These parameters may be but are not limited to cycle duration, shift location, if vehicles or equipment are needed for the operation, shift duration, rest-time between shifts, number of mandatory shifts, and off-time after completing ail the shifts, and other class variables such as number of employees needed on each team and shift. In one example, a class of 200 employees may have a cycle duration of 8 days, in a particular region of a city, and require a vehicle such as an ambulance for their job. In this example, the employees may have shifts of 12 hours and may have a mandatory 4 shifts in a cycle, with 12-hour rest-time between shifts, and 4 days of off-time after completing all the shifts. In this example, 25 ambulances are available for each shift, and since each team/ambulance needs two employees, 50 employees for any given shift are needed.

Once the classes are recorded, when a given class of employees is selected to create a schedule, the scheduling module 40 creates a hierarchical honeycomb structure 49 according to the selected class variables, and presents the hierarchical honeycomb structure 49 on the scheduling interface 44. The scheduling module 40 divides the whole cycle schedule 50 into a plurality of second tiers or shifts 51. The shifts 51 are then subdivided into a plurality of third tiers or teams 52. The third tiers are divided such that they are nested within the second tiers, that is, each of the teams 52 are arranged to be contained within their respective shifts 51. Each team 52 is further divided into a plurality of fourth tiers or positions 53. The fourth tiers are divided such that they are nested within the third tiers, that is, each of the positions 53 are arranged to be contained within their respective teams 52. If vehicles are needed for the class, teams 52 are displayed as vehicles and the positions 53 are displayed as vehicle seats. The number of employees needed for each shift 51 determines the number of positions 53. FIG. 3 is merely one example of the hierarchal honeycomb structure 49 having a plurality of tiers. Other arrangements and divisions of tiers may be possible. FIG. 3 shows the divisions or tiers as rectangles further divided into smaller rectangles further divided into circles. Other shapes and arrangements may be possible.

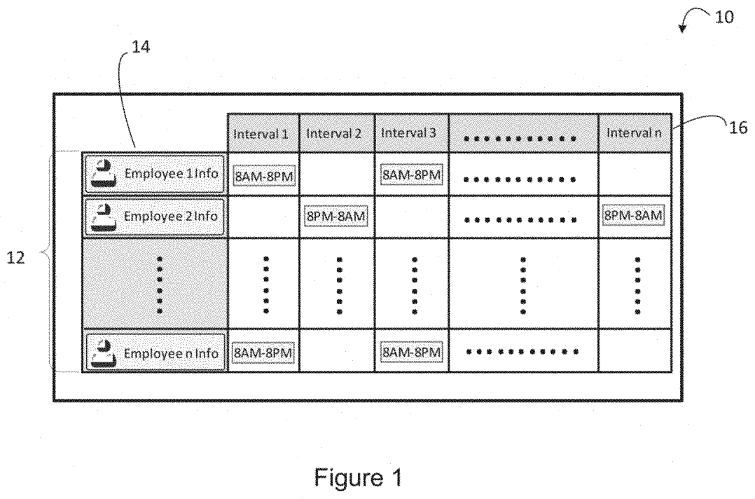

In a table-based system (FIG. 1), 3200 cells (200 employees×16 shifts) would be created. In the scheduling interface 44 of FIG. 2a and FIG. 3, there are 800 cells (50 positions in each shift) or positions 53 created, resulting in 2,400 (75%) less cells than a table-based system, reducing the size of the whole schedule substantially and saving the time in going through the cells.

In one embodiment of the scheduling interface 44, an employee may be represented by a geometrical shape or an avatar or a tag 54, which the employee or scheduler may choose. The tag 54 shows the identification number (ID) of the employee assigned by database 34 when the employee is registered into the system 20 for the first time. The tags 54 for all employees are placed in a floating employees pool 55. The pop-up or floating employees pool 55 window is movable around the screen and may be minimized, closed, and reopened. When a user hovers over or clicks a tag 54 with an input device (such as a mouse, touchpad or other input device), a dynamic employee information box 56, or pop-up employee window, appears, presenting the details about the employee. These employee details may include but are not limited to photo, full name, job title, division, and pay rate. This floating employees' pool 55 and dynamic employee information box 56 along with the hierarchical honeycomb structure 49 allows the scheduling interface 44 to save valuable screen real estate by approximately 90% compared to a typical table-based system, and allowing the user to see the entire schedule at once.

The scheduling module 40 uses the previous schedule data to determine the current cycle schedule. The data which may be used may include but is not limited to number and pattern of the previous cycle shifts, and the status of the employee for each shift in the previous cycle, such as, completed the shift, resting, or absent. The scheduling module 40 automatically populates a schedule while presenting the last cycle data and recommending shift details for the current cycle schedule, allowing the user or scheduler to review, compare, and interpret the data to make an informed decision via the scheduling interface 44.

In general, queries extract the data needed for each task from the server database 34, such as the previous cycle shift pattern, employees' availability for the current cycle, employees' details, etc. The algorithms used by the scheduling interface 44 utilize this data to recommend the current cycle shift pattern using the functions and the algorithms. The algorithms follow a logical approach for the recommendations. For instance, if an employee is supposed to be off for four days after completing four shifts, and has just completed four shifts in the previous cycle, the algorithms recommend four days off followed by four shifts. The algorithm does not copy the previous cycle shift data.

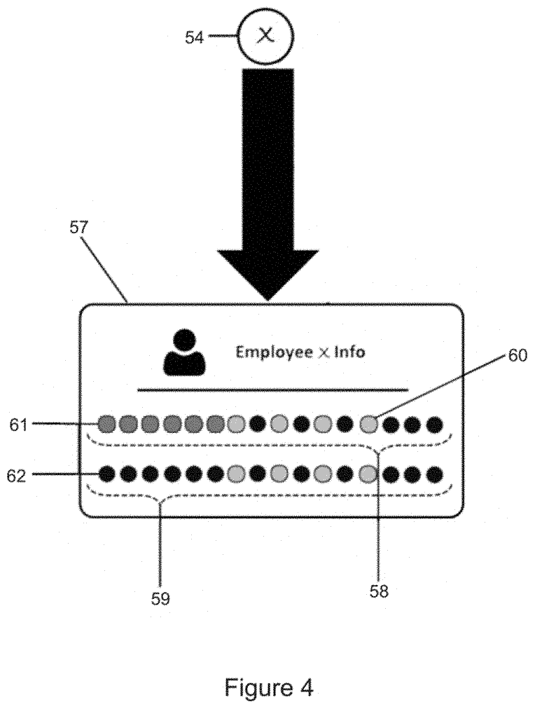

As shown in FIG. 4, the previous schedule 48 and the recommended current cycle schedule 59 shift data are represented in the same dynamic employee information box 56 with color-coded geometric shapes (circles, squares, hexagons, etc.). This dual schedule or “dual rosterogram” is a visual representation where previous shift data and current shift data are viewable in one interface. This dual rostergram within the employee information box 56 allows for a user to view and compare previous shift data and current shift data to make informed decisions. This dual rostergram within the employee information box 56 becomes available when a user hovers the mouse over or clicks on an individual tag 54 or through other input means from the user. In this example of FIG. 4, the previous schedule 48 and recommended schedule 59 are rows of circles traversing the dynamic employee information box 56. The number of shapes in each row corresponds with the number of shifts in each cycle. The color of each shape indicates the status of the employee for that shift. The status can include, but are not limited to on shift 60, on leave 61, rest-time 62. Other possible statuses may show more detailed leave such as sick-time or vacation days. Although the scheduling module 40 may be automated, the user or scheduler may be able to take control of the recommended shift pattern for the current cycle schedule via the scheduling interface 44. The user is able to see any employee's recommended schedule and previous schedule by calling up the dynamic employee information box 56, allowing the user to make comparisons and changes based on those comparisons.

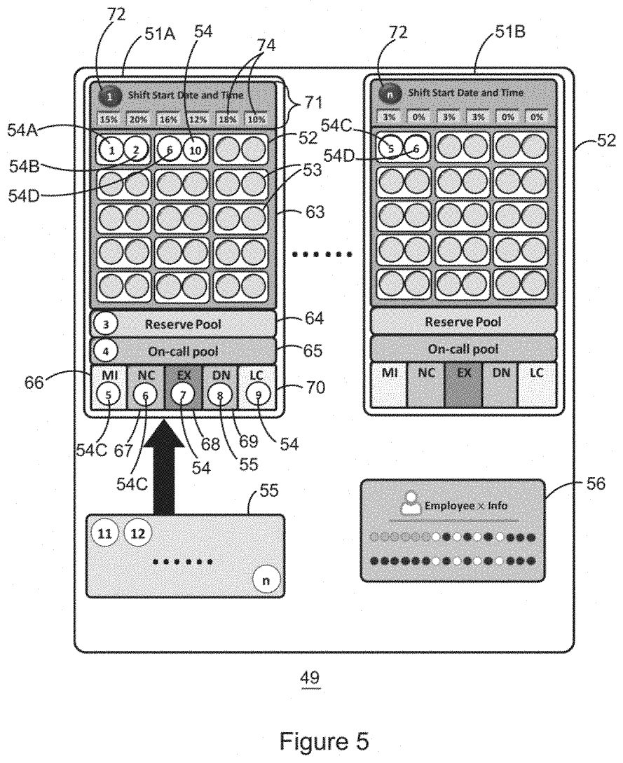

FIG. 5 shows an embodiment of the scheduling interface 44 in more detail. The whole cycle schedule 50 may be divided into shifts 51, which, in this example, are presented in a multi-pool shift structure. While this embodiment shows an eight-pool structure for illustrative purposes, any number of pool structure may be possible. In the example of FIG. 5, these pools are illustrated as a regular shift pool 63, a reserve pool 70, an on-call pool 65, a Moved Inside pool 69, a next cycle pool 67, an exempted pool 70, a deferred pool 69, and a last cycle pool 70. Other pools may be implemented during initialization and set up of the system 20, depending on the type and needs of the organizations, the employees, the resources required, and other factors.

In the example of FIG. 5, regular shift pool 63 contains the main teams 52 or vehicles and positions 53 or seats. The regular shift pool 63 is the main pool of the shift from which the schedule is drawn up. If two employee tags 54A, 38B are placed in the two positions 53 of a team 52 or vehicle, they will be working as partners for that shift and occupants of the same vehicle, Reserve pool 70 contains a pool or list of employee tags 54 that will be considered reserve for the shift, that is, employees who will be present on-site to fill in for anyone who does not show up for their appointed shifts. On-call pool 65 contains a pool or list of employee tags 54 that will be considered on-call for the shift. Employees in the On-call pool 65 are those employees who will not be present on-site but may be called to come into work if they are needed.

Moved Inside pool 69 contains a pool or list of employee tags for those employees whose shifts are inevitable for scheduling. It is common practice to move employees' shifts to other shifts to reduce shortages and overages. This Moved Inside pool 69 is used to leave a trace when a given employee's tag is moved to another shift in the same cycle, either earlier or later shift, either due to employee's request or by the scheduler. In this example illustrated in FIG. 5, a copy of the employee tag 54C numbered 5 is placed in the Moved inside pool 69 in the first shift 51A, and another copy of the employee tag 54C numbered 5 is placed in nth shift 51B, showing that employee tag 54C numbered 5 had an original shift in the first shift 51A, but it was moved to nth shift 518. The scheduling module 40 recognizes and accounts for the displacement in the next schedule. Moved Inside pool 69 sets up a trace of shift changes so that neither the employee, nor the organization will lose the time. If the trace is not left in place, the change in shift pattern will be a permanent change. For instance, if the original shift pattern was shifts 1, 3, 5, 7 and shift 1 was moved to shift 9, and no trace was left in the Moved Inside pool 69 for shift one, in the future cycles the scheduling interface 44 will consider the previous cycle pattern as shifts 3, 5, 7, 9 and the pattern is changed permanently from shifts 1, 3, 5, 7, to shifts 3, 5, 7, 9, but if a tag was put inside the moved inside of the first shift as the trace, in the next cycles the system would consider shifts 1, 3, 5, 7 as the pervious cycle pattern and the shift pattern would not change.

Next Cycle pool 67 is used to track when a given employee will be working the next cycle's shift earlier in the current cycle. As the example in FIG. 5 illustrates, a copy of employee tag 54D numbered 6 is placed in the Next, Cycle pool 67 of the first shift 51A, and another copy is placed in the regular shift pool 63 of the first shift 51A, this shows that the employee with the employee tag 54D numbered 6 is doing the Next Cycle shift 62 in the first shift of this cycle. The scheduling module 40 will consider this in the next cycle, and assigns one shift less to the employee in the next cycle.

Exempted pool 70 is a pool or list of employee tags 54 for those employees who are exempted from the current shift, their tag is moved from the regular shift pool 63, reserve pool 70, or on-call pool 65 into the Exempted pool 70.

Deferred pool 69 is a list or pool of employee tags 54 for those employees who are supposed to do this cycle's shift in the next cycle. The employee tags 54 for those employees are moved from the regular shift pool 63, reserve pool 70, or on-call pool 65 into the deferred pool 69. The scheduling module 40 will add an extra shift to the employee's schedule in the next cycle.

Last Cycle pool 70 is a pool or list of employee tags 54 for those employees who have done one or more of the shifts of this cycle in the last cycle. Those employee tags 54 are automatically moved from the regular shift pool 63, reserve pool 70, or on-call pool 65 into the last cycle pool 70. In this way, the scheduling module 40 will assign one less shift to the employee in the current cycle schedule.

The scheduling interface 44 may include a header 71 for each shift, which may contain shift details, such as date, time, shift number 72 and shift assessment indicators 74 such as skill level distribution based on the employees selected for each shift 51. As the employee tags 54 are moved into or out of a shift, the scheduling module 40 recounts and reevaluates the employees' details in each shift, and these indicators are updated dynamically, and the user can see the results of their action instantly.

The example of the eight-pool structure of FIG. 5, allows the user to schedule employees through a one-step process. The hierarchical honeycomb structure 49 shown in FIG. 3 and the eight-pool structure shown in FIG. 5 create a map in which each position 53 or pool has its own unique address, which is created when the user saves the schedule. This unique address is dynamic according to the class variables and where these elements are on the scheduling interface 44. When the user saves a schedule, the address is created, and data related to each employee is extracted from these addresses that are used for each tag of a given employee. For example, if an employee has 4 tags, each tag has its own address. The address is created and used only when the user has completed the scheduling and clicks the save button. In another example, second seat in the fifth available ambulance with plate number 56B356 of the third regular 12-hour shift of the tenth cycle which starts at 8 AM of 14 Aug. 2018 for the third class of employees in the central region of the city as the partner of employee with ID number 2 with skill level A is an example of this address for a position. This address allows the user or scheduler to move employees tags 54 from the floating employees pool 55 to and between the shift pools 54, 56, 58, 60, 62, 64, 66, 68 by drag-and-drop or clicks from an input device. After an employee tag 54 is placed in a pool, the scheduling module 40, when the schedule is saved, will automatically assign the following details depending on the pool the employee's tag is placed in: cycle details (start date, start time, etc.), shift times (start date, start time, duration, etc.), shift location, team details (ID, etc.), employee's details (ID, name, skill level, etc.), partner details (ID, name, skill level, etc.), shift type (regular, reserve, on-call), shift status (moved inside, next cycle, exempted, deferred, last cycle), vehicle details (type, number, etc.), vehicle status available, reserve, in repair, etc.), alerts for partner mismatch (e.g., skill level mismatch', employee status (e.g., on leave), existing tag of the same employee (double assignment). These are merely examples of the types of details that may be assigned during scheduling and other details may he implemented depending on the type of organization or employees.

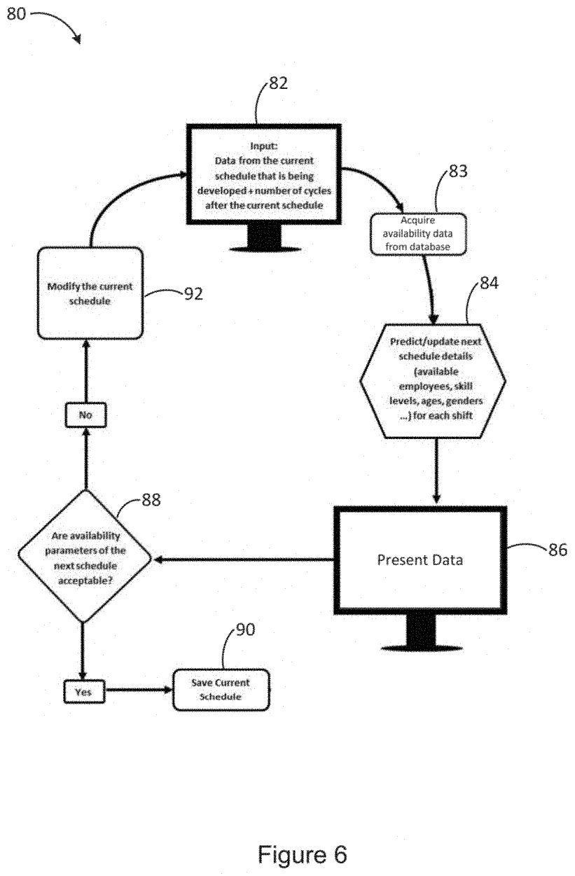

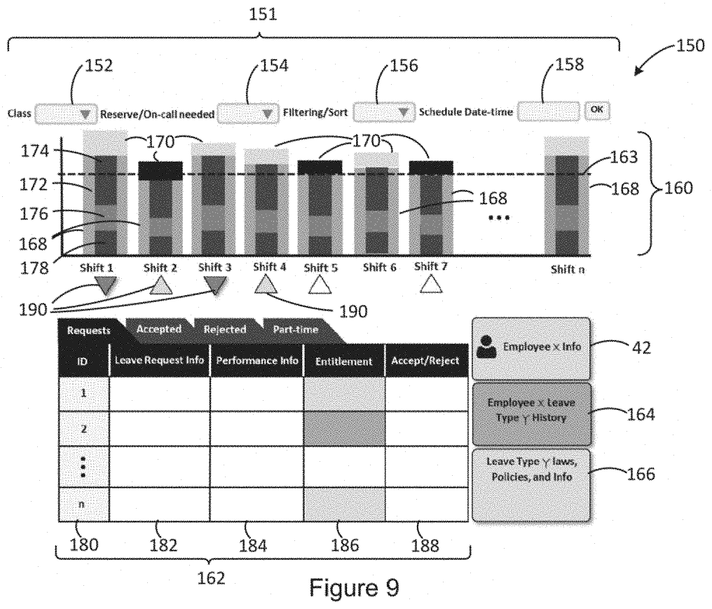

FIG. 6 shows a method 80 where the user or scheduler may assess the schedule being developed and any changes that may affect future schedules. The method 80 reduces shortages and overages in the next cycles. In step 82, a schedule (current cycle schedule) is created (not saved yet), and a user inputs the number of cycles that will occur after the current cycle schedule. In step 83, the scheduling interface 44 via the scheduling module 40 will query the database 34 to acquire employee availability data for the next schedule according to the number selected by the user. In step 84, the scheduling module 40 will use the current cycle schedule and the employee availability data to predict the next cycle schedule. This availability data may include but is not limited to availability of employees with approved leave time, part-time employees, and employees with sick-leave or vacation time. The next cycle schedule may include the number of available employees and their skill levels and other employee information. In step 86, the scheduling module 40 presents the details of each shift in the next cycle in a chart on the scheduling interface 44 (described in FIG. 9 below). In step 88, the user or scheduler determines if the shift parameters are acceptable as shown by the chart. In some embodiments this determination may be automated by the system 20, which would then be approved or modified by the user. If the shift parameters are acceptable, then in step 90, the next cycle schedule is saved to the database 34. If the shift parameters are not acceptable, then in step 92, the user may modify the next cycle schedule by moving employee tags 54, accepting or canceling leave or vacation requests to accommodate employee shortages or overages. The method 80 returns to step 82, where the user changes in step 92 are treated as inputs and the next cycle schedule is recreated.

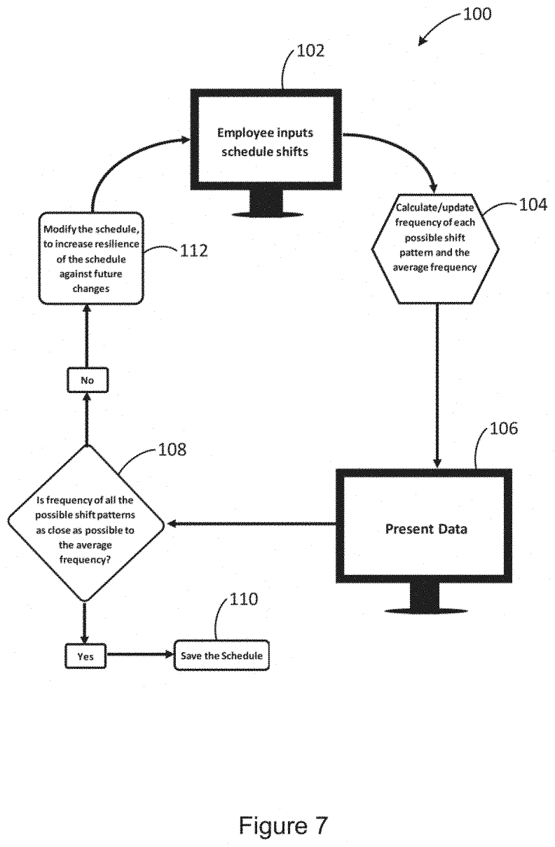

FIG. 7 shows a method 100 for increasing the resilience of a schedule to potential future changes such as sick leave or emergency leave. In step 102, the data in the current cycle schedule (not saved yet) is acquired by the scheduling module 40. In step 104, the scheduling module 40 uses the data from the current cycle schedule to calculate the frequency of the possible shift patterns and the average frequency of the possible shift patterns in the entire schedule. In one example made for illustrative purposes, eight shifts are numbered 1, 3, 5, 7, 9, 11, 13, and 15, and four employees are required for each shift In this example, 3 possible shift patterns are used, including [1, 3, 5, 7], [9, 11, 13, 15] and [5, 7, 9, 11]. The user assigns four employees to a set of shifts 1, 3, 5, and 7, and assigns five employees (four needed plus one extra employee) to a set of shifts 9, 11, 13, and 15, but assigns no employees to a set of shifts 5, 7, 9, and 11. Then, for the first set of shifts or shift pattern, the frequency is four. For the second set of shifts or shift pattern, the frequency is five. For the third set of shifts or shift pattern, the frequency is zero. The average frequency of the schedule is (4+5+0)/3=3. Although there are no employees for the shift pattern 5, 7, 9, and 11, all eight shifts have 4 or more employees, and all the shifts are filled. Because only two shift patterns are used in this example, if a first employee from the first shift pattern (1, 3, 5, 7) becomes sick or has an emergency causing them to leave work, that first employee should be replaced by an employee from the second shift pattern (9, 11, 13, 15). The difficulty in replacing the first employee with the second employee is that it is likely the second employee has completed shift 15 of the previous cycle and this will make 5 shifts in a row for the second employee. However, having the extra employee in the third shift pattern 5, 7, 9, 11 would allow the user to replace the first employee with this employee whose last shift is 11 and has had some days off between the last shift of the previous cycle and the first shift of this cycle. Therefore, if the frequency of each shift pattern is close to the average frequency of the possible shift patterns in the entire schedule, the schedule is more resilient and recoverable to potential changes.

In step 106, the scheduling module 40 presents the frequencies of each possible pattern and the average frequency of the shift patterns in the entire schedule on the scheduling interface 44. In step 108, the user determines if the shift pattern frequencies are close to the overall average of the shift patterns in the entire schedule. If the shift pattern frequencies are close to the overall average, then, in step 110, the next cycle schedule is saved to the database 34. If the shift pattern frequencies are not close to the overall average, then, in step 112, the user may make changes to the next cycle schedule by modifying the shift patterns of the employees. The method 100 returns to step 102, where the modifications of step 112 are treated as an input and the calculations and presentation are repeated.

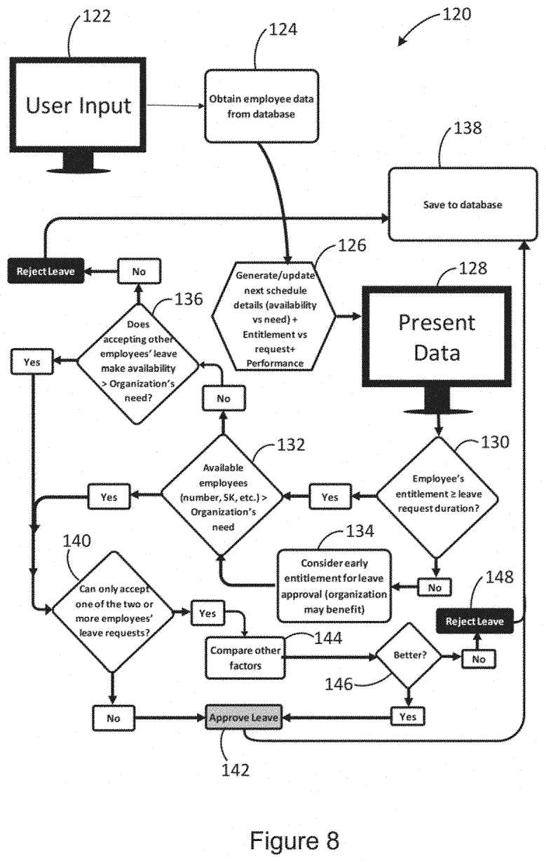

FIG. 8 shows a method 120 for managing employee leave times. FIG. 9 shows an example of a leave management interface 150. As described earlier, in the implementation of the scheduling system 20, employees are organized in classes. The leave management interface 150, may have a header 151 which allows a user to select such options as a class 152, the number of reserve or on-call employees needed 154, sorting and filtering options such as, request time or leave start time 156, and the date and time 158 of the schedule. The date and time 158 may be the date and time of the current cycle schedule, that is published and implemented by the scheduler, or the next cycle schedule that is not developed yet. In method 120, these selections are inputted into the leave management interface 150 in step 122. In step 124, the leave management module 41 acquires data from the database 34 regarding, but not limited to employee details, employees' leave requests, part-time employee availability, selected cycle leave requests, organizational requirements, labor regulations and policies, employees' leave entitlements, employees' performance data, and previous cycle schedule data for the selected cycle. In step 126, if the selected date and time of the schedule 158 is in the future, the leave management module 41 creates the recommended shift patterns for the next cycle automatically using the logical algorithm used in method 80 for forecasting and the scheduling interface 44 for creating recommended shift patterns. In step 126, if the date and time of the schedule 158 is not in the future, the leave management module 41 acquires the saved schedule data from the database 34. In step 128, the leave management module 41 presents the data to the user via the leave management interface 150. As an example, suppose that the date today is May 10, and a schedule for May 6-14 has been published and implemented, therefore May 10 represents the middle of this schedule, however, the schedule for May 15-22 (next cycle) has not been developed. If an employee requests two days of vacation from May 17 to 19, the scheduling system 20 or HR staff are not able to determine, or forecast, whether there will be a sufficient number of employees on May 17-19, as the schedule for that cycle has not been developed yet. Accordingly, the leave management module 41 automatically creates the schedule for that cycle and provides the employees availability and need information for each shift of the May 15-22 cycle without the need to create that schedule first, and then determine whether there is indeed a sufficient number of employees before accepting the leave request. Accordingly, a current schedule that is being developed is capable of being modified for leave management i.e. active forecasting.

An example of the presentation of the data is seen in more detail in FIG. 9. In the example of FIG. 9, the presentation is divided into five sections: an organization needs chart 160, a leave request table 162, the dynamic employee information box 56, a dynamic employee leave history 164, and a dynamic labor relations and policies box 166. The organization needs chart 160 includes an organization's need line 163. The organization's need line 163 is determined when the system 20 is implemented. For example, if employees require a vehicle, the number of positions in each vehicle multiplied by the number of available vehicles determines the number of employees needed for a class for each shift. In another example, in a call center where four employees are needed for each shift, this need is provided to define the class.

Each shift is represented separately by a bar 168. Each bar comprises a plurality of boxes. The top of each bar 170 may have a color-code to indicate if the number of employees on leave, and if the number of available employees is more than the need (for example, the color code 170 may be yellow) or if the number of available employees is less than the need (for example, the color code 170 may be red), the available employees 172, and the distribution of skill level of employees 174, 176, 178.

Turning back to FIG. 8, in step 130, when the user selects a first employee's leave request, the user may check the requested leave duration versus the amount of leave to which the employee is entitled. If the leave duration is less than the entitled duration, then in step 132, the user checks the organization's need in the organization need chart 160, to see if the number of employees available is more than the number of needed employees. In some embodiments, step 132 may be automated by the system to check the organization's need and a message box may appear automatically to show whether or not the number of employees available is more than the number of needed employees.

If the leave duration is not less than or equal to the entitled duration, then, in step 134, the user can consider granting the request if the number of available employees is higher than the demand. For instance, in a scenario described for illustrative purposes, an employee was hired 11 months ago, and has requested two days of vacation. Although this employee typically would not be granted leave for another month due to the organizational policies, it may benefit the organization if the leave was approved if there are more available employees than needed (step 132). Depending on the organization's needs, in a month's time approval may not be granted.

If the organization's need is not greater than the number of available employees, then in step 136, the user checks the organization need chart 160 to see if accepting a second employee's leave request would make room for the first employee's leave request. By accepting a request, the chart and other elements of the leave management interface 150 are updated, and the user may see the results of their decision instantly. In one example, an employee whose shift pattern is 1-3 has submitted a vacation request for shifts 1, 2, 3, and 4. If the leave is accepted, the decision has two immediate results:

1) the number of available employees in Shifts 1 and 3 is reduced;

2) the number of available employees in shifts 5 and 7 will increase because the employee will be back from vacation and will complete the skipped shifts during shifts 5 and 7. As a result, in the next shifts, the number of available employees is increased, and this creates opportunity to accept another employees' leave request for those shifts.

Therefore, if accepting other leave requests makes room to accept a given employee's request, the method moves to step 140; otherwise it will be rejected in step 136 and the method returns to step 138 where the rejection will be saved to the database 34.

In step 140, the user determines if the number of leave requests for a given range is more than what the user can approve, that is, if the user is only able to accept one of two or more. leave requests. If the user is able to select more than one leave request, then, the request is approved in step 142. Otherwise, the user will compare other factors in step 144, such as the employees' performance, or reasons for leave, or last date of return from leave. In step 146, the user will select one of the requests based on which employee has better other factors, and that employee's request is approved in step 142, and the others' requests are rejected in step 148. The method 120 then returns to step 138 where the decisions are saved to the database.

Turning back to FIG. 9, once method 120 is complete, the organization needs chart 160 will show instantaneously how the approval of leave requests decreases the number of available employees in some shifts but increases the number in the next shifts, creating room to accept more leave requests. This allows the organization to see the immediate effects accepting or rejecting leave requests.

The leave requests table 162 shows employees represented by their IDs or tags 54 in the ID column 180. The leave requests table 162 may show in subsequent columns such information as the leave requests details 182 (e.g., duration, start date), the performance data 184 (e.g. number of shifts completed in the current year), the leave entitlement data 186, and the accept/reject 188 of the employee's leave request buttons. In the leave entitlement data 186 column, cells may become color-coded depending on such factors as if the requested leave duration is more than entitled leave duration. In this example the cell may become red. If the requested leave duration is less than entitled leave duration, the cell may become green. Other color coding and other factors for entitlement may be possible.

On clicking a given employee's request, the leave management interface 150 may display the range of the leave requested with arrows 190 under the shifts that will be affected. These leave range arrows 190 may be color-coded, for example gray upwards arrows. The leave range arrows 190 appear as different employees are selected. For instance, two employees may have requested the same duration of leave starting at the same date and time and have the same range of the leave from shift 1 to shift 4. But the shift pattern of the first employee may be 1, 3 and shift pattern of the second employee may be 2, 4. As a result, although their requests details are completely the same and the leave range arrows 190 point to the same shifts (1-4), the affected shifts are different for the two employees if the leave is granted, as a result shifts 1 and 3 arrows are highlighted and turned upside-down, for example red downwards arrows, for the first employee, while shift 2 and 4 arrows are highlighted and turned upside-down, for example red downwards arrows, for the second employee.

This design allows the user to have access to all the different data needed at once to make an informed decision.

Unless otherwise explained, all technical and scientific terms used herein have the same meaning as commonly understood by one of ordinary skill in the art to which this disclosure belongs. Although any methods and materials similar or equivalent to those described herein can be used in the practice for testing of the method and system, the typical materials and methods are described herein. In describing and claiming the method and system, the following terminology will be used.

It is also to be understood that the terminology used herein is for the purpose of describing particular aspects only and is not intended to be limiting. Patent applications, patents, and publications are cited herein to assist in understanding the aspects described. All such references cited herein are incorporated herein by reference in their entirety and for all purposes to the same extent as if each individual publication or patent or patent application was specifically and individually indicated to be incorporated by reference in its entirety for all purposes. To the extent publications and patents or patent applications incorporated by reference contradict the disclosure contained in the specification, the specification is intended to supersede and/or take precedence over any such contradictory material.

In understanding the scope of the present application, the articles “a”, “an”, “the”, and “said” are intended to mean that there are one or more of the elements. Additionally, the term “comprising” and its derivatives, as used herein, are intended to be open ended terms that specify the presence of the stated features, elements, components, groups, integers, and/or steps, but do not exclude the presence of other unstated features, elements, components, groups, integers and/or steps. The foregoing also applies to words having similar meanings such as the terms, “including”, “having” and their derivatives.

In addition, all ranges given herein include the end of the ranges and also any intermediate range points, whether explicitly stated or not.

Terms of degree such as “substantially”, “about”and “approximately” as used herein mean a reasonable amount of deviation of the modified term such that the end result is not significantly changed.

What is claimed is:

1. A computer-implemented method to cause a display device to dynamically render and update a scheduling interface for shift work for at least one employee, comprising: providing, by operation of a computer processor, instructions causing a display device to dynamically render and update the scheduling interface for shift work, the scheduling interface comprising:
a current schedule comprising:
a plurality of classes comprising a group of employees for performing a particular task or operation; and
wherein each class of group of employees comprises schedule parameters comprising at least one of a cycle duration, shift location, equipment required for the operation, shift duration, rest-time between shifts, number of mandatory shifts, and off-time after completing all the shifts, and number of employees needed on each team and shift;
wherein the schedule comprises a hierarchal honeycomb structure having a plurality of classes; and
wherein an employee may be represented by at least a geometrical shape, an avatar and a tag, and wherein at least a geometrical shape, an avatar and a tag is selectable for placement in a pop-up employees pool window movable around the display device; and wherein at least a geometrical shape, an avatar and a tag is selectable for dynamically cause a display of a pop-up employee information window on the display device; and
wherein the pop-up employees pool window and the dynamic employee information box and the hierarchical honeycomb structure substantially minimizes the display device real estate attributable to the scheduling interface, thereby the entire current schedule to be displayed on the display device to permit a user to view the entire current schedule at once.

2. The scheduling interface of claim 1, wherein the display device real estate attributable to the scheduling interface is minimized by up 90%.

3. The scheduling interface of claim 2, further comprising at least one prior schedule based on previous shift data, whereby the current schedule and the at least one prior schedule are simultaneously displayed on the display device for comparison,

4. The scheduling interface of claim 3, wherein the pop-up employee information window comprises the employee's prior schedule and the current schedule dynamically generated and recommended by the computer processor, and comprising a status associated with the employee, the status including at least one of a shift, on leave, rest-tire, sick-time and vacation days.

5. The scheduling interface of claim 4, wherein the recommended schedule current is changeable by a user via the scheduling interface.

6. A computer-implemented system for dynamically creating and updating a schedule for shift work comprising:
a processor in communication with at least one database for storing employee data, availability data, resources data, previous scheduling data, leave data;
a scheduling module in communication with the processor and the at least one database for utilizing the employee data, the availability data, resources data, and the previous scheduling data to create the schedule, wherein the schedule comprises a plurality of nested tiers to form a hierarchal honeycomb structure;
a leave management interface module in communication with the processor and the at least one database for processing employee leave data and dynamically updating the schedule based on the employee leave data;
a user interface in communication with the processor, the leave management module and the scheduling module and the at least one database, the user interface accepting user input for dynamically updating the leave management module and the scheduling module, wherein the scheduling module allows user input to dynamically update the schedule via the user interface; and
wherein the hierarchal honeycomb structure schedule is displayed on the user interface.

7. The computer-implemented system of claim 6, wherein a leave management user interface coupled to the leave management module is used to approve and/or reject employee leave requests made through the employee interface, saving the approved and rejected employee leave requests as the leave data to the at least one database

8. The computer-implemented system of claim 7, wherein the plurality of nested tiers has a first tier representing a cycle, a second tier within the first tier representing a plurality of shifts of employees, a third tier representing a plurality of teams of employees, and a fourth tier representing a plurality of positions.

9. The computer-implemented system of claim 8, wherein the plurality of positions is populatable with a plurality of employee tags, each of the plurality of employee tags representing an employee.

10. The computer-implemented system of claim 9, wherein the scheduling user interface displays a presentation of employee data upon selection of an employee tag from the plurality of employee tags.

11. The computer-implemented system of claim 10, wherein the presentation of employee data includes current schedule data and previous schedule data associated with the employee tag.

12. The computer-implemented system of claim 8, wherein the scheduling user interface displays frequencies of shift patterns for the plurality of shifts of employees for the schedule based on the schedule and previous schedule data, the frequencies allowing the user to view gaps in the shift patterns and to make decisions based on the frequencies.

13. A computer-implemented method for dynamically creating and updating a schedule for shift work, the method implemented utilizing one or more processors for executing computer instructions stored in a computer readable medium to perform the steps comprising:
acquiring employee data, availability data, resources data, previous scheduling data, leave data from at least one database;
creating, via a scheduling module in communication with the at least one database, the schedule based on the employee data, the availability data, resources data, and the previous scheduling data; wherein the schedule is formatted in a plurality of nested tiers to form a hierarchal honeycomb structure;
displaying the hierarchal honeycomb structured schedule via a scheduling interface;
updating dynamically the schedule via a scheduling interface, based on user input;
receiving automatically from the at least one database leave data created by a leave management module in communication with the at least one database; and
updating dynamically the schedule with the leave data.

14. The computer-implemented method of claim 13 wherein the leave data includes employee leave requests are approved and/or rejected by the leave management module.

15. The computer-implemented method of claim 13, wherein the plurality of nested tiers has a first tier representing a plurality of classes of employees, a second tier within the first tier representing a plurality of shifts of employees, a third tier representing a plurality of teams of employees, and a fourth tier representing a plurality of positions.

16. The computer-implemented method of claim 16, wherein the plurality of positions is populatable with a plurality of employee tags, each of the plurality of employee tags representing an employee.

17. The computer-implemented method of claim 16, further comprising displaying a presentation of employee data, via the scheduling interface, upon selection of an employee tag from the plurality of employee tags.

18. The computer-implemented method of claim 17, wherein the presentation of employee data includes current schedule data and previous schedule data associated with the employee tag.

19. The computer-implemented method of claim 13, wherein the scheduling interface displays frequencies for the plurality of shifts of employees for the schedule based on the schedule and previous schedule data, the frequencies allowing the user to view gaps in the shifts and to make decisions based on the frequencies.

20. A computer program product comprising a non-transitory computer usable medium having a computer readable program code embodied therein, the computer readable program code configured to be executed by a computer processor and cause the computer processor to perform a method for dynamically creating and updating a schedule for shift work, the method comprising the steps of:
acquiring employee data, availability data, resources data, previous scheduling data, leave data from at least one database;
creating, via a scheduling module in communication with the at least one database, the schedule based on the employee data, the availability data, resources data, and the previous scheduling data;
displaying the schedule on a user interface, wherein the schedule is formatted in a plurality of nested tiers to form a hierarchal honeycomb structure;
updating dynamically the schedule via the user interface, based on user input;
receiving automatically from the at least one database leave data created by a leave management module in communication with the at least one database; and
updating dynamically the schedule with the leave data.
